(19) United States
(12) Patent Application Publication
(10) Pub. No.: US 2023/0259961 A1
(43) Pub. Date: Aug. 17, 2023

(54) METHOD FOR PROCESSING DRINKING EVENTS AND SYSTEM TO BE USED FOR THIS METHOD

(71) Applicant: Re-Company SA, Geneva (CH)

(72) Inventors: Francesco ABBATE, Chambesy (CH); Eduardo ATAMOROS VON DER ROSEN, Corsier (CH); Pierandrea QUARTA, Genf (CH)

(21) Appl. No.: 18/006,754

(22) PCT Filed: Aug. 14, 2020
(86) PCT No.: PCT/EP2020/072910

§ 371 Date: Jan. 25, 2023

(51) Int. Cl. G06Q 30/0226

(52) U.S. Cl. CPC G06Q 30/0226

(57) ABSTRACT

Prior art smart bottles have incorporated electronic components and in particular sensors. A method for processing drinking events out of such bottles is disclosed herein. According to the method, drinking bottles are provided, each being connected to an evaluation system that recognizes drinking events from one of the respective drinking bottles. If the evaluation system of one of the drinking bottles recognizes a drinking event, information about the drinking event is stored and afterwards written to a blockchain in the form of a digitally signed transaction as part of a block of the blockchain.

### FIELD OF APPLICATION AND PRIOR ART

The invention relates to a method for monitoring dispensing processes from a bottle as well as to a smart bottle system for carrying out this method.

Reusable drinking bottles are known from the prior art. Those bottles can be refilled by the user, for example with tap water. It is also known to provide such reusable drinking bottles with electronic components by means of which, for example, it can be detected how much liquid remains in the bottle or whether the user has drunk from the bottle sufficiently often. Such bottles are referred to as smart bottles. Examples of reusable smart drinking bottles including drinking cups with electronic components and closures therefor are known from various documents like US 2020/0029714 A1, US 2019/0298607 A1, U.S. Pat. No. 10,315,815 B2 and US 2017/0313479 A1.

It is desirable, especially for ecological reasons, that the user who uses the reusable drinking bottle and consumes water from this bottle instead of drinking from disposable bottles which are usually not or only to a limited extent reused. Such disposable bottles represent a large proportion of the plastic waste produced by mankind. Many billions of such bottles every year are not recycled but end up in the environment.

In order to motivate users to consume as much water as possible from the above-mentioned reusable smart drinking bottles, it may be helpful to provide a reward system for using the bottle. Such a reward system makes it necessary to store information about the drinking events and to make this information publicly available.

### OBJECT OF THE INVENTION AND SOLUTION

The purpose of the invention is to provide an advantageous way of storing and managing drinking events that can serve as the basis for a reward system.

According to the invention a method is proposed, according to which drinking bottles are provided, each being connected to an evaluation system of the respective drinking bottle. Said evaluation system recognizes drinking events from the respective drinking bottle, in particular using sensors being located on or in the drinking bottle.

According to a possible design of such a bottle the evaluation system has a distance sensor, which is preferably directed from a hinged lid into a bottle body of the bottle and which can determine the distance to the liquid surface. Repeated measurements can be used to determine whether liquid has been dispensed.

Additional sensors which can be used in course of the method according to the invention are temperature sensors and inclination or acceleration sensor. Such sensors can be used to determine with quite a high degree of certainty whether the dispensed liquid has been dispensed in course of a drinking process. Possible ways to evaluate the sensor data in order to distinguish drinking processes from other dispensing processes are to measure the dispensing time or liquid low in order to find out whether it is plausible, to evaluate the movement of the bottle to detect whether a swallowing movement has taken place and/or to evaluate whether the user's face is positioned at a dispensing opening of the drinking bottle.

It is provided according to the invention that information about the detected drinking event is written to a blockchain in form of a digitally signed transaction as part of a block of the blockchain.

Such a transaction represents a composition of information for the blockchain. Said action is distributed over a peer-to-peer network to so-called validation nodes. These validation nodes check the integrity of the transaction. If it is valid, it is processed by the so-called miners. These miners which are usually computers connected to the internet create blocks in which several transactions are bundled.

The creation of such blocks is based on finding a nonce that leads to a valid block hash of the block. Once a miner has achieved this goal, the valid block is added to the blockchain and this addition is synchronized between the computers operating with the blockchain.

Since each subsequent block depends on the previous one, blocks once inserted into the blockchain are unchangeable. If a block would be actually changed, this would lead to an invalid block hash of all following blocks, so that the manipulation would be easily recognizable.

The bottles evaluation system can initiate the appending of a block with information on the drinking event directly after the drinking event took place or at least send information about the drinking event to a server structure directly. Contrary thereto it is preferred that the writing to the blockchain does not take place directly. Instead the evaluation system stores the amount of liquid drunk during and initiates writing to the blockchain only in case a predefined amount of liquid has been reached. This predefined amount of liquid may correspond to a full bottle, for example to 500 ml. In case the initiation of the writing to the blockchain takes place only after such a predefined amount of liquid has been reached, the reaching of said predefined amount of liquid is understood as drinking event in the sense of this invention.

Regarding the owner of the digital signature for digitally signing the transaction to be added to a blockchain block there are two possible modes of operation.

In the first mode of operation the digital signature used for digitally signing the transaction is a digital signature specific for the bottle or specific for the user of the bottle. This mode is in particular used if the transaction is directly composed by the personal evaluation system of the bottle or a personal mobile device of his owner with a bottle application being part of the evaluation system.

In an alternative mode of operation, the digital signature is a digital signature being used identically for multiple bottles or of all bottles of the specific bottle system. This mode of operation is being used primarily if a central server structure is provided, wherein the evaluation system communicates with said central server structure in order to inform the central server structure about the drinking event or multiple drinking events. In this case the central server structure composes the transaction and thus preferably signs it with a digital signature assigned to this server structure or to the company owning and running the server structure.

Preferably the transaction contains at least a unique identifier of the drinking bottle or an information derived from the unique identifier or linked to the unique identifier in a database. Therefore, it can be identified from which bottle or whose bottle it has been drunk causing the transaction. In case the transaction is signed digitally with a key assigned to the specific bottle or its user, usually no additional unique identifier is needed as the digital signature is a unique identifier by itself.

Furthermore, additional data linked to the drinking event can be stored in the transaction added to the blockchain, for example data regarding the point in time the drinking event has occurred and data regarding the location where the drinking event has occurred.

It is preferred that a public blockchain is being used for storing the information about the drinking events.

Such a public blockchain already provides all infrastructure components required for its operation, i.e. in particular validation nodes for checking the transactions and miners for inserting the transactions into a block of a blockchain. This means that there is no need to set up such an infrastructure specifically for processing the drinking transactions. In particular the Ethereum public blockchain has proven to be a good choice.

If a system with a central server structure is being used, the evaluation systems of the drinking bottles send information about the drinking events to said central server structure in order to have the information about the drinking event written to the blockchain. The central server structure then composes lists of the received drinking events, preferably on a regular basis, for example on a daily basis. This list contains all drinking events regarding which information has been sent from the bottles' evaluation system to the central server structure and which have not yet been added to the blockchain.

After having composed this list, the central server structure initiates the writing of the composed list to the blockchain. This is usually being done by adding this list to a transaction, for example as a XML or PDF attachment, signing this transaction digitally with the server's digital signature or a signature of the company running the server structure and broadcasting this blockchain transaction to a P2P network belonging to the blockchain, in order to get the transaction validated and afterwards added to a block of the blockchain.

If the system is designed for decentral composing of the transactions, the bottle's evaluation systems itself compose a blockchain transaction in order to have the information about the drinking event written to the blockchain. As described above the transaction can refer to a single drinking event or to aggregated drinking events, especially to drinking events together concerning a dispensing of one full bottle volume like for example 500 ml.

This blockchain transaction is then digitally signed by the evaluation system, preferably with a digital signature of the bottle itself of its owner. Said signature is usually stored in the application on the mobile phone being part of the evaluation system. Afterwards having been signed the blockchain transaction is broadcasted by the evaluation system to a peer-to-peer network belonging to the blockchain, in order to get the transaction validated and afterwards added to a block of the blockchain.

In the described systems a single blockchain, in particular a public blockchain, is being used for storing the drinking events. An alternative embodiment is different as it provides two blockchains for storing information about drinking events.

The first of these two blockchains is being used for storing information on drinking events, wherein transactions stored in a block of the first blockchain refer to drinking events of a single transaction-specific bottle. Preferably the storing of information regarding the drinking events in this first block takes place such that each of the bottle's evaluation systems initiate the storing of the related drinking events in the first blockchain. A central server structure is not needed for writing to the first blockchain. Alternatively, it could also be the central server structure to compose these transactions for the first blockchain on basis of messages from the individual bottle evaluation systems about drinking events having taken place.

This first blockchain is preferably a private blockchain in order to allow an inexpensive operation. As the costs of mining new blocks could be relevant when a public blockchain is being used and a single transaction for each drinking event is composed and added to the blockchain, the usage of private blockchain reduces these costs.

The second blockchain which is preferably the above-mentioned public blockchain is being used to store transactions with aggregated information from multiple transaction of the first blockchain. Therefore, if for example 1,000 drinking events (each referring to one full bottle consumption) using 500 bottles took place on a single day, these 1,000 drinking events lead to 1,000 transactions in the first blockchain, but only to a single transaction in the second blockchain, containing information of the 1,000 drinking events of multiple bottles.

Preferably a central server structure is provided for reading the drinking event transaction from the first blockchain and for composing the transaction for the second blockchain.

The storing of drinking events in the blockchain is a reliable method as basis for a reward system as it is not possible to change data from the block chain after a block has been appended. Both the information leading to rewards as well as the rewards themselves can be stored in the blockchain.

For such a reward system it is preferred that a smart contract is provided, which can be also stored in the blockchain, said smart contract being adapted to automatically create a green certificate token once the information about the drinking event has been written to the blockchain.

This green certificate token is a reward generated in reaction to drinking out of the reusable drinking bottle and thus avoiding disposable bottles. In technical terms this reward is a data structure which can be transferred using blockchain transactions. The generation of green certificate tokens can take place directly as reaction to the corresponding drinking event or in reaction to a subsequent action, in particular a cleaning event having taken place in reaction to the drinking event as further described below.

The smart contract is a computer program intended to digitally facilitate the performance of a contract. Smart contracts allow the performance of credible transactions without third parties. In this specific case the contract contains as condition for its performance the drinking event or said subsequent event, in particular the cleaning event. If the condition has been met, the contract's consequence is being triggered, namely the creation of the green certificate token.

The green certificate token can directly be created or transferred to a specific recipient while this transfer is stored in the blockchain. Said recipient could be a company whose employee is user of the corresponding bottle and/or the green certificate token could be sold to this or another company. The recipient can for example use the green certificate credits as proof for this commitment to the environment.

As already mentioned, a method is preferred in course of which for each drinking event a cleaning event is initiated, said cleaning event comprising the removal from waste from the environment, in particular the removal of a waste bottle from the coastal environment. This is a further motivation for the user to use the reusable drinking bottle instead of disposable bottles.

The transmittal of the drinking event to a service provider or organization for causing the initiation of the cleaning event can performed via the blockchain. Therefore, the service provider or cleaning organization can see from the blockchain data how many new drinking events have taken place and can thus initiate the cleaning by sending cleaning teams to beaches or other places in nature to collect waste bottles or other waste.

It is preferred that after the cleaning event has taken place, the information about the cleaning event is written to the blockchain. Thus, the blockchain contains not only information about the drinking events with the described reusable bottles, but also information on the cleaning caused by this. Preferably this is also being used as data for the application on the user's mobile device where both information regarding the usage of the reusable bottle and the collecting of waste can be checked by the user.

The costs for the cleaning action are preferably paid by the company receiving the green token certificate, which usually is the company whose employee is user of the bottle. In particular, it is planned that companies will purchase the described bottles for their employees and, as a result, will be entitled to purchase the green tokens and use them in advertising, for example. The green token certificates generated by the employees are thus transferred to the employing company using further blockchain transactions.

The information on the personal usage of the reusable bottle and the positive impact on the environment is shown to the user preferably on his smart phone display by the mentioned application. Furthermore, it is preferred that a central dashboard is provided, preferably in form of an internet web site, on which information about the drinking events in the blockchain is shown. This central dashboard therefore preferably reads the needed information form the block chain.

Besides the described method the invention also concerns a system for data-processing the use of a drinking bottle comprising a drinking bottle and an evaluation system which is designed to be used for the describes method. The evaluation system of the bottle has at least one sensor for detecting the dispensing of liquid from the bottle, said sensor being fastened in or on the bottle. Furthermore, the evaluation system has at least one computing unit with a program capable of detecting drinking events, creating blockchain transactions containing information regarding detected drinking events and broadcasting these transactions via internet to validation servers.

Such a system preferably comprises the bottle itself and a mobile device like a smart phone, both comprising a subunit of the evaluation system, said subunits being connected via a wireless network. The evaluation system preferably has the ability to directly initiate the writing of a transaction regarding drinking events.

### SHORT DESCRIPTION OF THE DRAWINGS

Further advantages and aspects of the invention result from the claims and from the following description of preferred embodiments of the invention, which are explained below using the figures.

FIGS. 1 and 2 show a smart bottle together with its evaluation system.

FIGS. 3 and 4 show a first variant of the method, wherein a diagram explaining the main consecutive steps of the method is shown in FIG. 4.

FIGS. 5 and 6 show a second variant of the method, wherein a diagram explaining the main consecutive steps of the method is shown in FIG. 6.

FIGS. 7 and 8 show a third variant of the method, wherein a diagram explaining the main consecutive steps of the method is shown in FIG. 8.

FIG. 9 shows a final part of the method, which illustrates steps towards a reward system made possible by the blockchain.

### DETAILED DESCRIPTION OF THE EXAMPLES

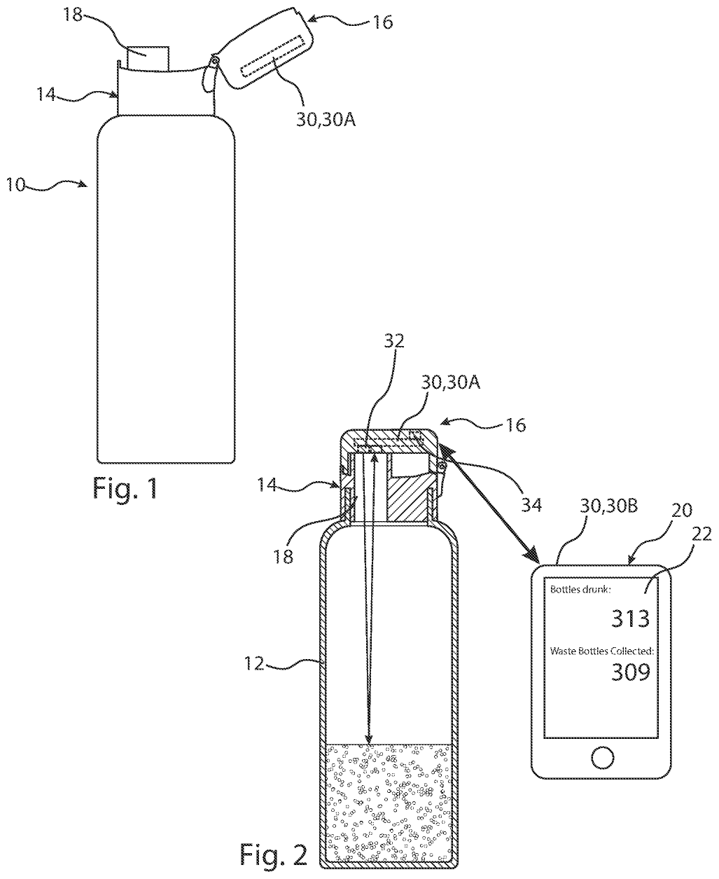

FIGS. 1 and 2 show a drinking bottle 10 for repeated use. The drinking bottle 10 has a bottle body 12 and a lid unit 14 with a hinged lid 16, by which a drinking opening 18 is closeable and which can be opened for drinking.

In the hinged lid 16 a first subunit 30A of an electronic evaluation system 30 is provided. This first subunit 30A has various sensors, including a sensor 32 for detecting the liquid level in the bottle body 12, for example a time-of-flight sensor.

The sensors of the first subunit 30A are thus able to detect how much liquid has been removed from the drinking bottle 10 by comparing the liquid level before and after the usage of the bottle. Other sensors, which are not shown in detail, can be designed to distinguish whether the liquid was actually drunk or dispensed in some other way. Furthermore the first subunit 30A has a commuting unit 34 running a computer program for managing the sensors and for communication.

The evaluation system 30 preferably also has a second subunit 30B, which is formed by a mobile device as a smartphone 20 with an application installed on it. In an alternative design, the entire evaluation system 30 could also be installed in the drinking bottle 10, especially in its hinged lid 16. In this case the computing unit 34 would be designed for direct internet access without a mobile device as relay.

The first subunit 30A and the second subunit 30B are connected to each other by a wireless connection, preferably by a Bluetooth connection. The smartphone 20, which forms the second subunit 30B, has an Internet connection by means of which data can be exchanged with servers on the Internet.

Via this Internet connection, the evaluation system 30 can forward the recorded liquid consumption from the drinking bottle 10 to external systems. According to the invention, this is done with the aim of storing the drinking events and the associated liquid consumption in a blockchain 64, 74, 84, 94, i.e. in a decentralized managed data structure. The information stored in a blockchain 64, 74, 84, 94 is stored in the form of blocks 62, 72, 82, 92, whereby blocks added later in time contain hash values of the respective previous block. A later modification or removal of a block from the blockchain is therefore not possible without being recognizable due to the then no longer consistent hash values of the subsequent blocks.

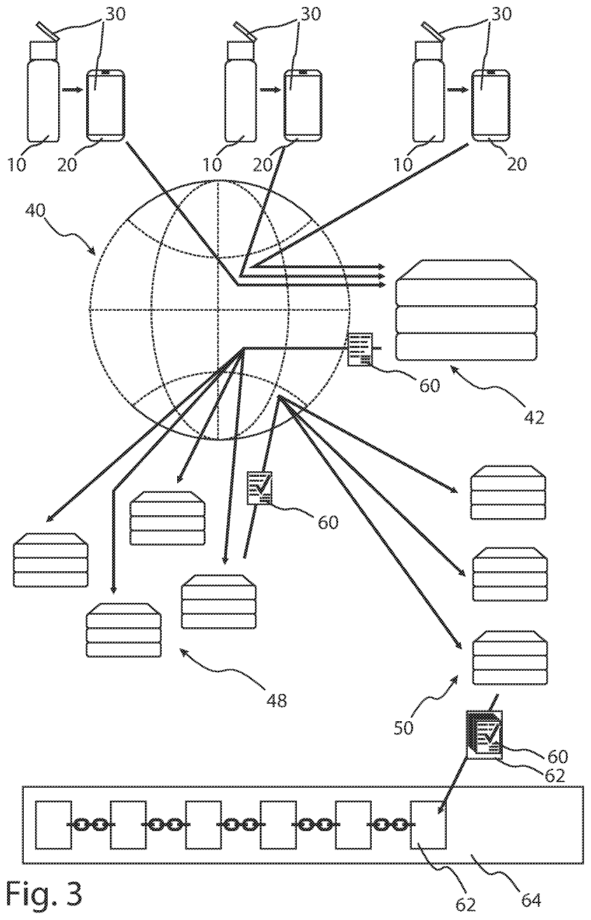

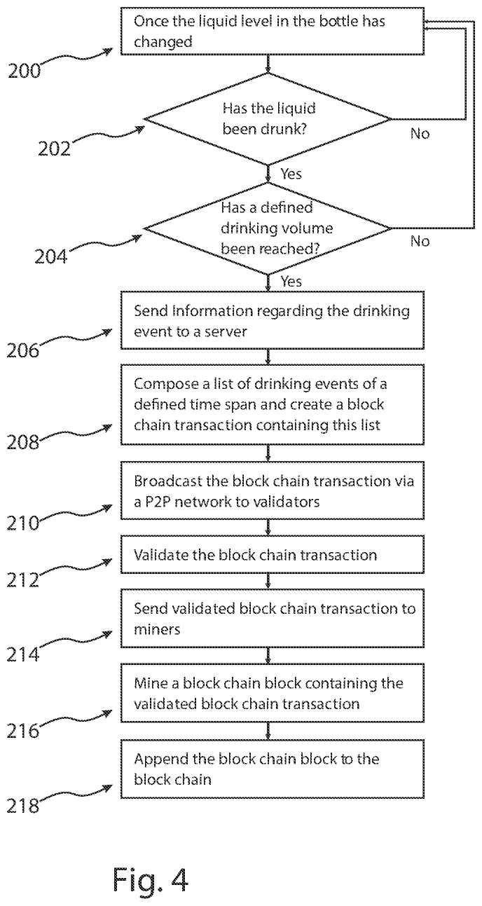

FIG. 3 shows a first variant of the procedure according to the invention using such drinking bottles 10 as described for FIGS. 1 and 2. The corresponding procedure is shown in diagram form in FIG. 4.

The drinking bottles 10 are used by users in their everyday life to drink water from them, in particular previously filled tap water. The user thereby avoids the purchase of disposable bottles.

Each of the drinking bottles 10 is assigned by the evaluation system 30 to a smartphone 20 on which the mentioned application is installed. This application communicates on the one hand with the first subunit 30A of the evaluation system 30 in the hinged lid 16 of the drinking bottle 10 and on the other hand via the Internet 40 with servers on the Internet, in particular in this variant with a central server structure 42.

Dispensing processes are noticed by a sensor system provided for this purpose, preferably the sensor system described in FIGS. 1 and 2 (step 200). If the dispensing process is recognized on the basis of sensor data as drinking process (step 202), the data on the dispensing process in the drinking bottle 10 is sent to the application forming the second subunit 30B of the personal evaluation system 30, specifying the quantity of dispensed liquid. The application stores the information about the reported amount of liquid drunk by the user. If the quantity reaches a predefined level (step 204), for example 500 ml, the stored value is reset and a data packet about the amount of liquid consumed is sent to the central server structure 42 via the Internet 40 (step 206).

Immediately after receiving such a message or in longer intervals, the central server structure 42 initiates the addition to a blockchain 64 in which the information about the amount of fluid consumed is to be stored. A transaction 60 is generated for this purpose (step 208). Information on the quantities of liquid consumed is written into this transaction, whereby preferably information on a plurality of drinking bottles and/or consumption over a specified period, for example 24 hours, is combined in a transaction 60. The transaction 60 is signed digitally by the central server structure 42 and is therefore assigned to it.

The transaction 60 is then broadcasted via the Internet 40 and a peer-to-peer communication structure to further computers (step 210), the so-called validation nodes 48. These validation nodes 48 check the transaction 60 for validity (step 212). If the transaction 60 is valid, it is marked accordingly and made available to 40 so-called miners 50 via the Internet (step 214). The miners 50 combine many transactions into a block (step 216), whereby following the blockchain principle this can be accompanied by gaining units of a crypto currency. The miner 50, which was first able to create a valid block, receives the unit of the crypto currency. The block 62 generated by this miner 50 with a plurality of transactions and with the transaction 60 of the central server structure 42 is included in blockchain 64 (step 218). As illustrated in FIG. 3, the newly included block 62 is concatenated with the previous block in the manner specific to blockchains by containing the hash value of the previous block. A later removal or modification of the new block 62 is therefore no longer possible.

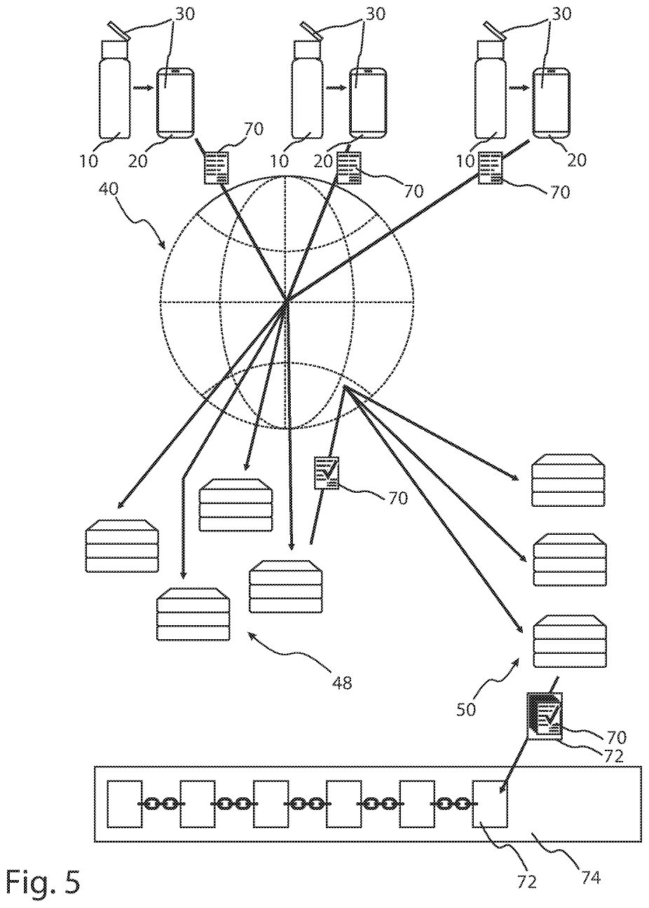

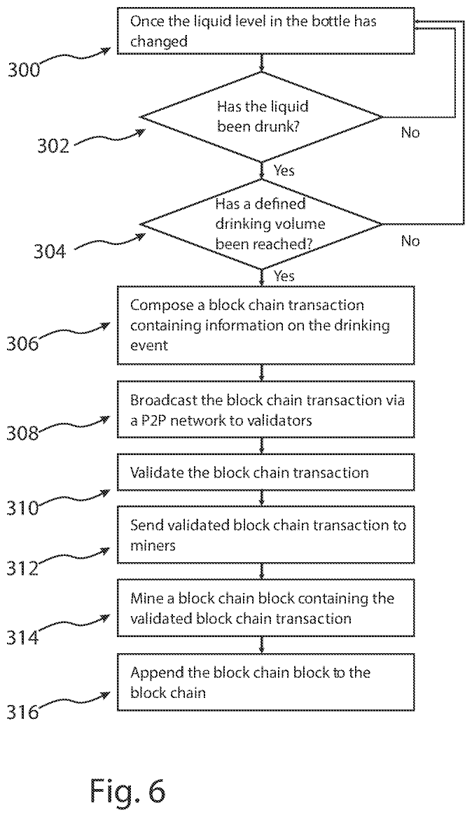

FIGS. 5 and 6 show a second variant of the procedure according to the invention.

In this variant of the procedure, no central server structure corresponding to the central server structure 42 of FIG. 3 is being used for amending the blockchain. Instead, it is the drinking bottles 10 or the assigned applications on the smart phones 20 themselves that generate transactions 70 (step 306) after a dispensing process (step 300) and a check whether the dispensing was carried out by drinking (step 302) and whether a predefined amount of, for example, 500 ml is reached (step 304). These transactions 70 are signed with a digital signature that is specific to the respective drinking bottle 10 or its user.

The transactions 70 are sent to validation nodes 48 (step 308), which check the transactions 70 for validity (step 310) and, if valid, make the transactions marked as valid available to the miners 50 (step 312), so that the respective transactions 70 are included into a block 72 (step 314) and this block 72 is included in the blockchain 74 (step 316) in the same way as described above for the first variant.

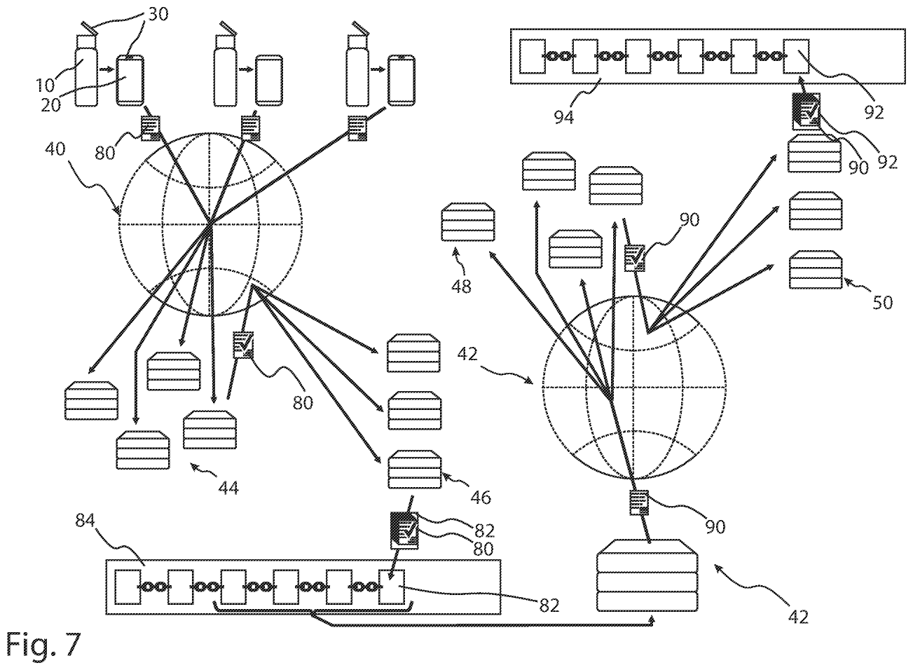

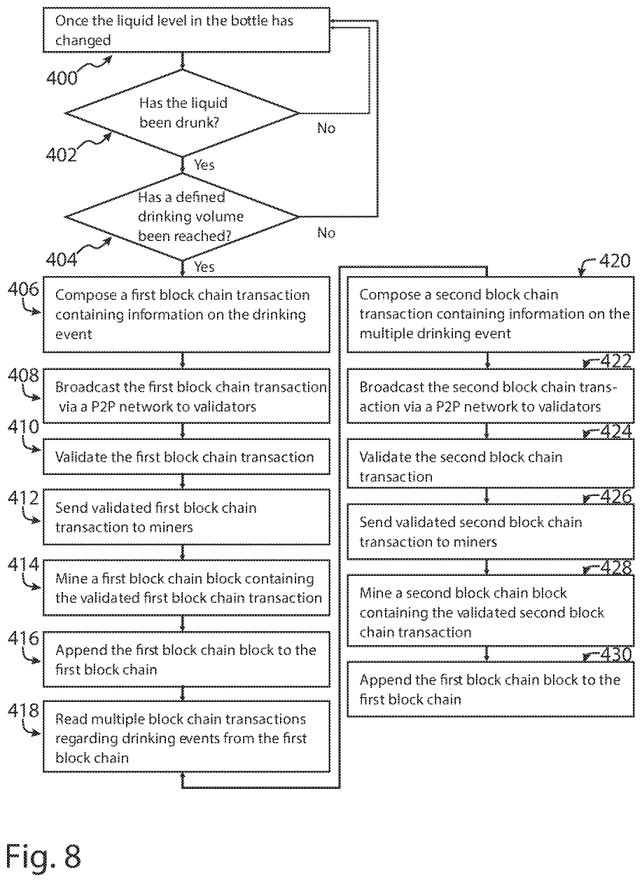

FIGS. 7 and 8 show a third variant of the procedure according to the invention. In this third variant, the procedure initially largely corresponds to the procedure in FIGS. 5 and 6. Starting from the recording of the dispensing of liquid (step 400) by the evaluation systems 30 of the drinking bottles 10, it is determined whether the respective dispensing has taken place by drinking the liquid (step 402) and whether the specified amount volume of, for example, 500 ml has been reached (step 404). If this is the case, the evaluation system 30 of the respective drinking bottles 10 generate a transaction 80 with information on the drinking event (step 406) and send this to validation nodes 44 (step 408). If the transaction 80 is judged to be valid (step 410), it is forwarded to miners 46 (step 412) to be included into a block 82 (step 414) and appended to the blockchain 84.

Up to this point, the procedure is largely the same as that described in FIGS. 5 and 6. However, unlike blockchains 64, 74, blockchain 84 is not a public blockchain but a private blockchain. In this way, the costs associated with the generation of blocks can be reduced. Corresponding to the use of a private blockchain, the validation nodes 44 and the miner 46 are also different from the public blockchains 64, 74, as described in the case of the first two variants.

However, the variants of FIGS. 7 and 8 also provide for the drinking processes to be finally documented in a public blockchain 94.

For this purpose, it is provided that a central server structure 42 regularly reads out the transactions 80 from the private blockchain 84 newly added there and concerning drinking events, in particular the number of drinking bottles emptied, including a unique identification for the drinking bottle or the user (step 418).

Based on this, the central server structure 42 generates a new transaction 90, in which information from a plurality of transactions 80 is summarized (step 420) and sends this transaction 90 to validation nodes 48 of the public blockchain 94 for validation (step 422). The validation nodes 48 check the validity of transaction 90 (step 424) and, if positive, send it to the miner 50 of the public blockchain 94 (step 426). The miners 50 create a new block 92 containing the transaction 90 of the server structure 42 (step 428) and append it to blockchain 94 (step 430).

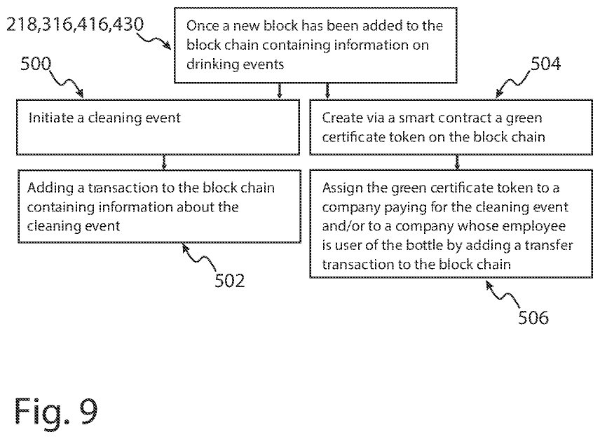

The methods described in FIGS. 3 to 8 describe how to store information about drinking events in a blockchain. This storage is usually also carried out to trigger further actions based on this information. This is explained in FIG. 9.

If a new block 62, 72, 82, 92 with at least one transaction 60, 70, 80, 90 containing information about a drinking event is appended to one of the blockchains 64, 74, 84, 94, this can be used as a trigger for handling a reward offered for drinking from a drinking bottle instead of using disposable bottles.

In particular, the removal of waste bottles from nature can be this reward and can be initiated in response to the drinking events and the storage of these events in the blockchains 64, 74, 84, 94. For example, if at the end of a day, new transactions concerning the consumption of 10,000 water bottles are included in blockchain 64, 74, 84, 94, an order can be given to an organization that organizes the collection of waste from beaches, wherein according to said order 10,000 waste bottles shall be collected (step 500).

Once this order has been processed, it may be provided that in a further step 502 the fulfilment of the collection of waste bottles is noted in the blockchain, preferably in such a way that a logical relationship is established with transaction 60, 70, 80, 90 and with the corresponding drinking events. The storing of the collection in the blockchain 64, 74, 84, 94 is done in the described manner by the generation of a transaction, the validation of the transaction and the appending of the transaction in a blockchain block by a miner.

The storage of the information about collected waste bottles allows a user to read on the display 22 of his mobile phone 20 not only the information how many bottles of water he has already drunk from the bottle, thus avoiding the production of disposable bottles, but also the information how many waste bottles he has already collected from the environment.

Besides information shown on the display 22 by the mentioned application, it is helpful to provide a dashboard accessible in a browser as webpage in order to show additional information, in particular information on the overall usage of the system, in particular the number of disposable bottles replaced by reusable bottles and the overall number of waste bottles collected.

Likewise, the inclusion of a block with a transaction involving information about a drinking process can lead to the creation of a so-called green certificate token in the blockchain, according to a smart contract that is also stored in the blockchain. Said green certificate token is a certificate data structure that is generated as a reward for the drinking process and/or the collection of a waste bottle (step 504).

This certificate can be transferred in the blockchain to a recipient immediately upon creation or by means of another transaction that is inserted into the blockchain (step 506). This recipient can be a company whose employee was the user of the bottle from which the water has been consumed. However, the certificate can also be purchased, so that the buyer can emphasize his commitment to the environment, for example in advertising campaigns.

1. A method for processing drinking events, the method comprising:
providing drinking bottles, each of the drinking bottles being connected to an evaluation system that recognizes drinking events from a respective one of the drinking bottles;
recognizing one of the drinking events of one of the drinking bottles with the evaluation system; and
writing information about the one of the drinking events to at least one blockchain in the form of a digitally signed transaction as part of a block of the at least one blockchain.

2. The method according to claim 1, wherein:
in response to the one of the drinking events, the evaluation system stores an amount of liquid drunk during the one of the drinking events and initiates writing to the at least one blockchain when a predefined amount of liquid has been reached.

3. The method according to claim 1, wherein:
a digital signature used for digitally signing the digitally signed transaction is a specific digital signature specific for the respective one of the drinking bottles or an owner of the respective one of the drinking bottles; or
the digital signature used for digitally signing the digitally signed transaction is a multiple digital signature being used identically for multiple ones of the drinking bottles.

4. The method according to claim 1, wherein:
the digitally signed transaction contains at least a unique identifier of the respective one of the drinking bottles or an information derived from the unique identifier or linked to the unique identifier in a database.

5. The method according to claim 1, wherein:
the at least one blockchain in which the information about the one of the drinking events is written to is a public blockchain.

6. The method according to claim 1, wherein:
the step of writing the information about the one of the drinking events to the at least one blockchain comprises the following steps:
composing a blockchain transaction containing the information about the one of the drinking events and digitally signing the digitally signed transaction;
broadcasting over a P2P network the blockchain transaction to several validation nodes;
validating the blockchain transaction by the several validation nodes;
providing the blockchain transaction that has been validated for inclusion in a blockchain block by a miner;
mining the blockchain block comprising the blockchain transaction that has been validated; and
appending the blockchain block that has been mined to the at least one blockchain.

7. The method according to claim 1, wherein:
in order to have the information about the one of the drinking events written to the at least one blockchain, the evaluation systems of the drinking bottles send information about the one of the drinking events to a central server structure;
the central server structure composes lists of drinking events on a regular basis; and
the central server structure initiates the writing of the composed list to the blockchain by broadcasting a blockchain transaction to a P2P network belonging to the at least one blockchain.

8. The method according to claim 1, wherein:
in order to have the information about the one of the drinking events written to the at least one blockchain, the evaluation systems of the drinking bottles compose a blockchain transaction; and
the blockchain transaction is broadcasted by the evaluation system to a P2P network belonging to the at least one blockchain.

9. The method according to claim 1, wherein:
the at least one blockchain comprises two blockchains for storing information about drinking events;
a first one of the two blockchains is used for storing information on the drinking events, wherein transactions stored in a block of the first one of the two blockchains refer to drinking events of a transaction-specific one of the drinking bottles and wherein transactions stored in a block of a second one of the two blockchains are composed from multiple transactions of the first one of the two blockchains and refer to drinking events of multiple bottles.

10. The method according to claim 1, wherein:
the blockchain comprises a smart contract, the smart contract being adapted to automatically create a green certificate token once the information about the one of the drinking events has been written to the blockchain.

11. The method according to claim 1, wherein:
the drinking events are processed by a subunit of the evaluation system which is separate from the one of the drinking bottles and wirelessly connected to the one of the drinking bottles, the subunit being a mobile device.

12. The method according to claim 1, wherein:
for each of the drinking events a cleaning event is initiated, the cleaning event comprising removal of waste from an environmental location.

13. The method according to claim 12, wherein:
after the cleaning event has taken place, writing information about the cleaning event to the at least one blockchain.

14. The method according to claim 12, wherein:
costs caused by the cleaning event is paid by a company.

15. The method according to claim 1, wherein:
the block further comprises at least one of:
data regarding a point in time when the one of the drinking events has occurred; or
data regarding a location where the one of the drinking events has occurred.

16. The method according to claim 1, further including:
providing a central dashboard comprising an internet web site, on which information about the one of the drinking events in the at least one blockchain are shown.

17. The method according to claim 1, wherein:
the evaluation system has at least one of a temperature sensor,
at least one inclination or acceleration sensor, and
at least one distance sensor.

18. The method according to claim 1, wherein:
the evaluation system is configured to distinguish the one of the drinking events from other dispensing events, whereby for this purpose a plausibility check is carried out with regard to a drinking speed, an evaluation of movement of the one of the drinking bottles to detect a swallowing movement taking place, and/or an evaluation whether a face of a user of the one of the drinking bottles is positioned at a dispensing opening of the one of the drinking bottles.

19. A system for data-processing drinking, the system comprising:
a drinking bottle;
an evaluation system designed to be used for processing drinking events;
at least one sensor for detecting dispensing of liquid from the drinking bottle; and
at least one computing unit with a program capable of detecting drinking events, creating blockchain transactions containing information regarding detected drinking events and broadcasting the transactions via Internet to validation servers.

20. The method according to claim 5, wherein:
the public blockchain is an Ethereum public blockchain.

21. The method according to claim 9, wherein:
the evaluation systems of the drinking bottles compose the transactions stored in the first one of the two blockchains and a central server structure reads the transactions stored in the first one of the two blockchains from the first one of the two blockchains in order to compose the transactions for the second one of the two blockchains; or
the evaluation systems of the drinking bottles send information about the drinking events to a central server structure and the central server structure composes the transactions stored in the first one of the two blockchains as well as a transaction for the second one of the two blockchains.

22. The method according to claim 10, wherein:
the green certificate token is transferred to a specific recipient as a transfer and the transfer is stored in the blockchain; and/or
the green certificate token is transferred to a recipient linked to the one of the drinking bottles of the one of the drinking events.

23. The method according to claim 11, wherein:
the subunit contains a program code for calculating an amount of liquid drunk during a last drinking event and for initiating writing about the last drinking event to the blockchain once a predefined amount of liquid has been reached.

24. The method according to claim 12, wherein:
the environmental location is a coastal environment.

25. The method according to claim 12, wherein:
a step of transmitting the one of the drinking events to a service provider is performed via the at least one blockchain.

26. The method according to claim 14, wherein:
in return for the payment, a green certificate token is transferred to a blockchain address linked to the company, wherein transferring the green certificate token occurs when a transaction is written to the at least one blockchain.
